(19) United States
(12) Patent Application Publication
(10) Pub. No.: US 2012/0186403 A1
(43) Pub. Date: Jul. 26, 2012

(54) MULTI-SIZE RATCHET SOCKET WRENCH

(76) Inventor: I-Su CHEN, Chang Hua Hsien (TW)

(21) Appl. No.: 13/040,265

(22) Filed: Mar. 4, 2011

(30) Foreign Application Priority Data
Jan. 26, 2011 (TW) 100102923

(51) Int. Cl. B25B 13/46; B25B 13/06; B25B 13/28

(52) U.S. Cl. 81/62; 81/60; 81/63.1

(57) ABSTRACT

A multi-size ratchet socket wrench comprises a ratchet unit disposed between a drive unit and a handle. The drive unit includes multiple forms of different sized engaging ends for driving different sized objects. Through the ratchet unit, the drive unit can rotate around the axial direction of the handle with respect to the handle and offers a ratchet function in the control direction of the user. By such arrangements, the multi-size ratchet socket can be applied in narrow space since it not only has multiple sizes of engaging ends but exerts a ratchet function, thus enhancing convenience in use.

### BACKGROUND OF THE INVENTION

1. Field of the Invention

The present invention relates to a hand tool, and more particularly to a multi-size ratchet socket wrench.

2. Description of the Prior Art

Referring to FIG. 1, a conventional multi-size ratchet socket wrench, which is a double-head drive tool 10 and commonly referred to as dog bone, is pivotally provided with a cross-shaped engaging tool head 11 at each of two opposite ends thereof. The engaging tool heads 11 each are formed with four different sized engaging ends 111, so that the double-head drive tool 10 totally has eight different sized engaging ends 111, thus enhancing the applicability of the wrench. However, in real application, the drive tool 10 also needs to be applied in a narrow space. For example, when the drive tool 10 is used in a narrow space having a certain depth, the handle of the drive tool 10, the tool head 11 and the working piece must be maintained on the same level in order to rotate the working piece. However, it is impossible for the user to rotate the drive tool 10 while holding the drive tool 10 in the mean time with one hand, instead, the user has to hold and rotate the drive tool 10 alternatively with two hands, which is very inconvenient. In addition, there is no sufficient space for rotation of the drive tool 10, so that it cannot satisfy all users' requirements.

The present invention has arisen to mitigate and/or obviate the afore-described disadvantages.

### SUMMARY OF THE INVENTION

The primary objective of the present invention is to provide a multi-size ratchet socket wrench which can not only have multiple sizes of engaging ends but offer a ratchet function for usage in a narrow space.

To achieve the above objective, a multi-size ratchet socket wrench in accordance with the present invention comprises a drive unit, and a ratchet unit.

The drive unit is provided at a first end thereof with a drive assembling element which is pivotally connected with a drive tool. The drive assembling element is formed at an end thereof with two opposite pivot ears extending in an axial direction, and the drive tool includes different sized socket engaging ends extending in multiple directions. The drive tool is pivotally connected between the two pivot ears.

The ratchet unit is arranged between the drive unit and a handle and selectively engaged to the handle to have different ratchet drive states in different rotating directions.

Since the drive tool includes the different sized socket engaging ends, the multi-size ratchet socket wrench in accordance with the present invention can be used to drive different sizes of objects. In addition, the ratchet unit between the handle and the drive unit can make the drive unit to rotate around the axial direction of the handle and provide a ratchet function with respect to the handle, enhancing the convenience in use.

### BRIEF DESCRIPTION OF THE DRAWINGS

FIG. 1 is a perspective view of a conventional multi-size socket wrench;

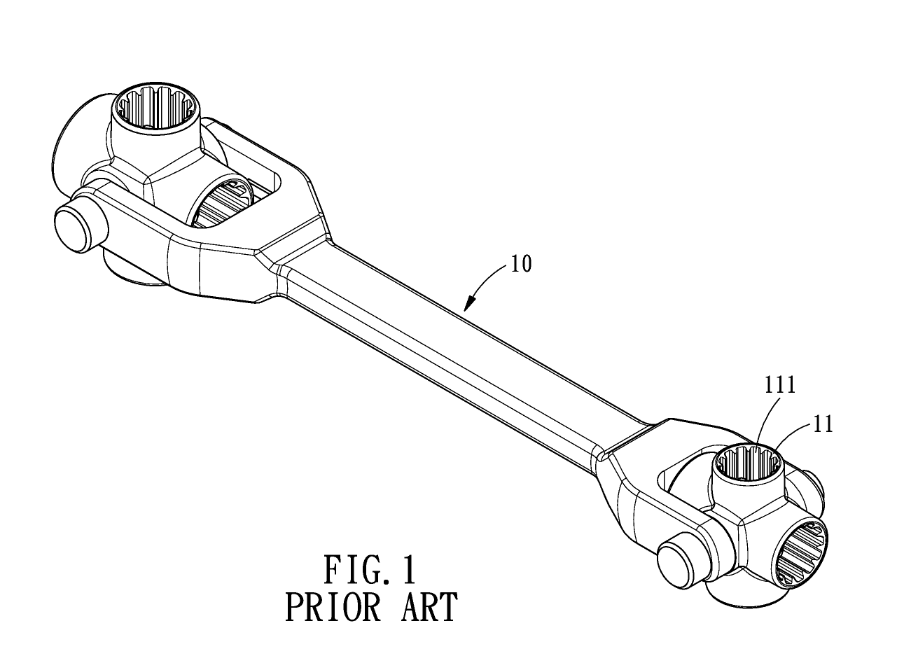

FIG. 2 is an exploded view of a multi-size ratchet socket wrench in accordance with the present invention;

FIG. 3 is a perspective view of the multi-size ratchet socket wrench in accordance with the present invention;

FIG. 4 is a cross-sectional view of the multi-size ratchet socket wrench in accordance with the present invention;

FIG. 5 is another cross-sectional view of the multi-size ratchet socket wrench in accordance with the present invention, showing that the ball is engaged in the engaging concave in the middle of the three engaging concaves;

FIG. 6 is another cross-sectional view of the multi-size ratchet socket wrench in accordance with the present invention, showing that the ball is engaged in the engaging concave at one side of the three engaging concave;

FIG. 7 is another cross-sectional view of the multi-size ratchet socket wrench in accordance with the present invention, showing that the ball is engaged in the engaging concave at the other side of the three engaging concave;

FIG. 8 is an exploded view of another ratchet unit in accordance with the present invention;

FIG. 9 is a cross-sectional view of another ratchet unit in accordance with the present invention, showing that the ratchet unit is in a complete engagement drive state;

FIG. 10 is a cross-sectional view of another ratchet unit in accordance with the present invention, showing that the ratchet unit is in a single-direction drive state;

FIG. 11 is a cross-sectional view of another ratchet unit in accordance with the present invention, showing that the ratchet unit is in another single-direction drive state;

FIG. 12 is a planar view showing that the drive unit of the multi-size ratchet socket wrench in accordance with the present invention is provided with five engaging ends;

FIG. 13 is a perspective view showing that both ends of the handle of the multi-size ratchet socket wrench in accordance with the present invention are provided with a ratchet unit and a drive unit; and

FIG. 14 is an exploded view showing another multi-size ratchet socket wrench in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

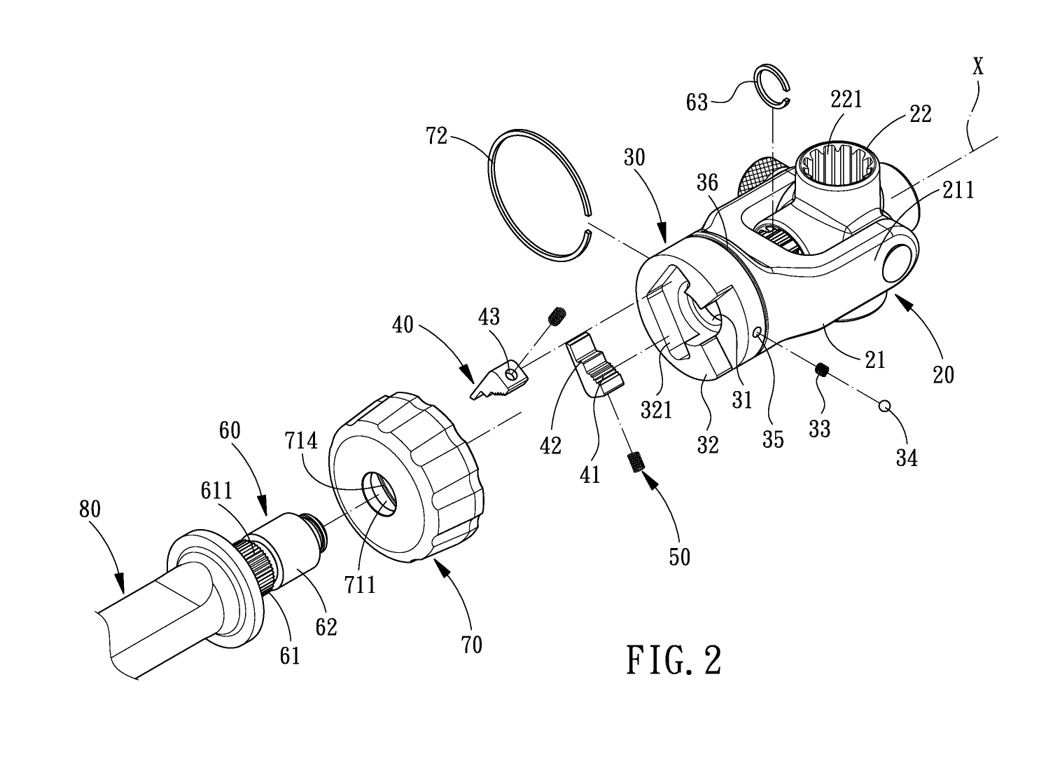

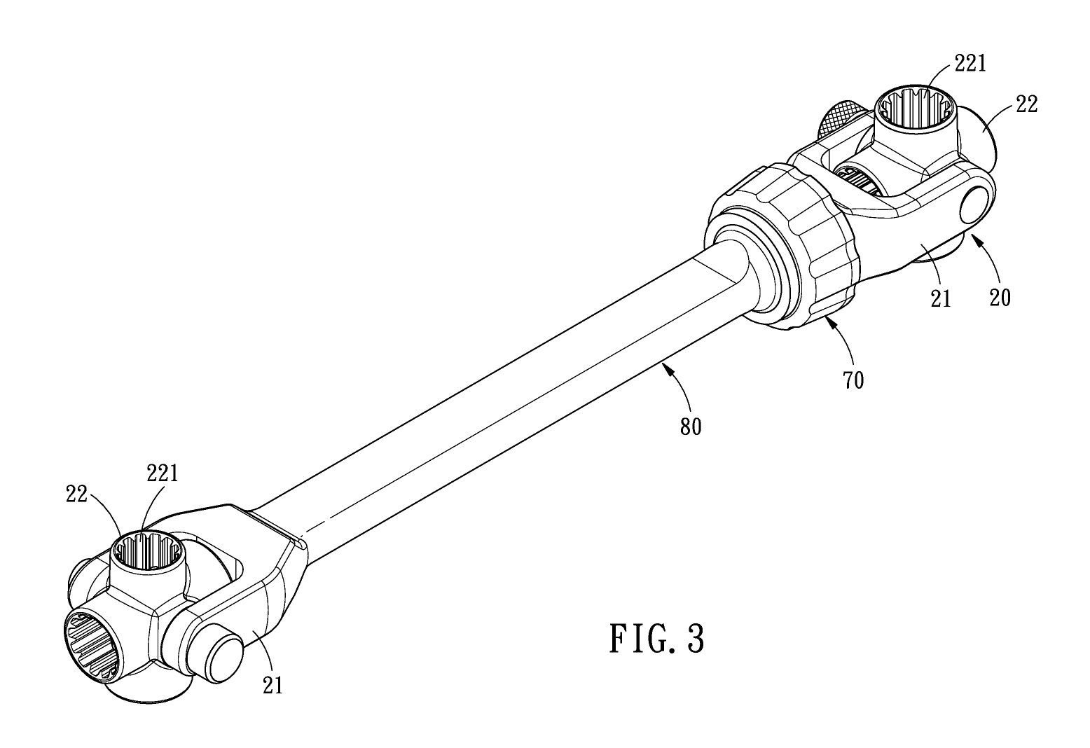

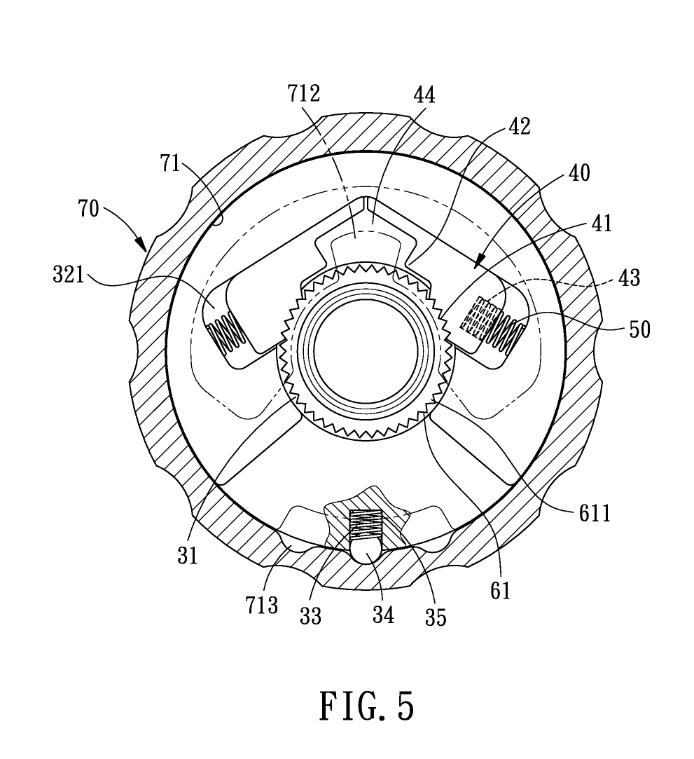

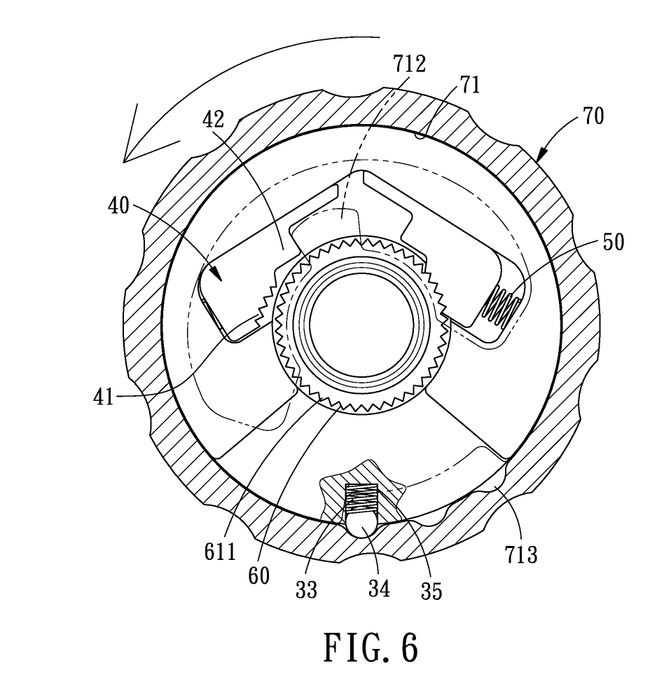

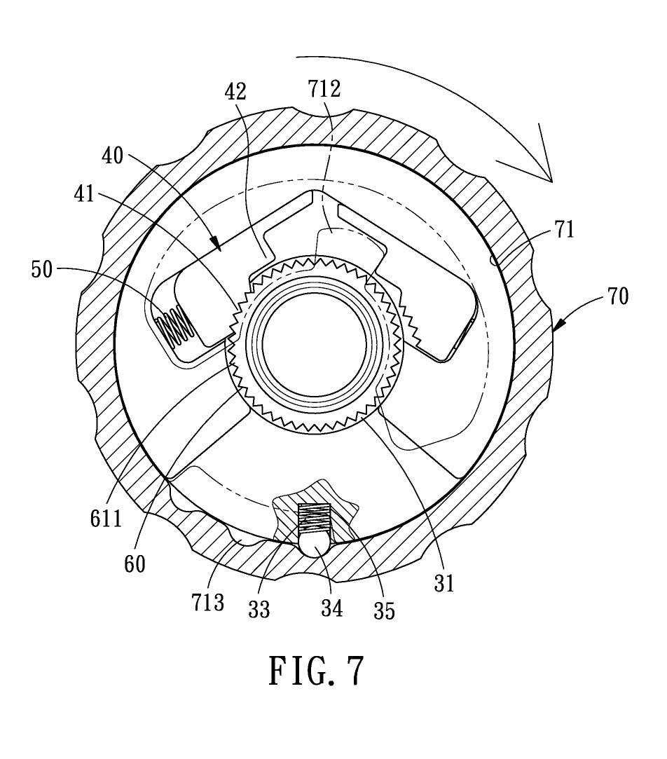

Referring to FIGS. 2-7, a multi-size ratchet socket wrench in accordance with the present invention is provided at an end thereof with a drive unit 20, an assembling base 30, and a ratchet unit.

The drive unit 20 is provided at a first end thereof with a drive assembling element 21 which is pivotally connected with a drive tool 22. The drive assembling element 21 is U-shaped and includes two opposite pivot ears 211 which extend in an axial direction X. The drive tool 22 in the present embodiment is cross-shaped in cross section and includes four different sized socket engaging ends 221 extending in different directions. The drive tool 22 is pivotally connected between the two pivot ears 211. The drive tool 22 can also be in other forms and include any number of engaging ends 221. Besides the sockets, the engaging ends 221 can also be square bars or other drive heads.

The assembling base 30 is connected to a second end of the drive unit 20. The assembling base 30 in the present embodiment is integral with the drive unit 20. The assembling base 30 is formed with a through hole 31 in the axial direction X and includes an end surface 32 in a direction vertical to the axial direction X. The assembling base 30 is formed with an accommodation groove 321 which is recessed in the end surface 32 and in communication with the through hole 31. The assembling base 30 is formed in an outer surface thereof with a ball groove 35 for accommodation of a ball 34 and a spring 33 and further formed with a first annular groove 36 around the outer surface thereof.

The ratchet unit is arranged between the drive unit 20 and a handle 80 to enable the drive unit 20 to be switched between idle and active states (to rotate idly with respect to the handle 80 or to unidirectionally drive the handle 80 to rotate). The ratchet unit in the present embodiment includes two engaging blocks 40, two elastic elements 50, a ratchet element 60 and a rotating cap 70.

The two engaging blocks 40 are accommodated in the accommodation groove 321 of the assembling base 30. Each of the two engaging blocks 40 is formed with ratchet teeth 41 in a direction of the through hole 31 and includes a driven portion 42 higher than the end surface 32 of the assembling base 30, and a side groove 43 at a side thereof. The two engaging blocks 40 are arranged in such a manner that the driven portions 42 are located adjacent to each other, and between the two engaging blocks 40 is defined a moving space 44.

The two elastic elements 50 are disposed in the respective side grooves 43 of the two engaging blocks 40 in such a manner that one end of each of the elastic elements 50 pushes against the corresponding side groove 43, and the other end of each of the elastic elements 50 pushes against an inner surface of the accommodation groove 321 of the assembling base 30.

The ratchet element 60 includes a ratchet portion 61 and a passage portion 62 at both ends thereof. The ratchet portion 61 is formed on an outer surface thereof with plural ratchet teeth 611 to be engaged with the ratchet teeth 41 of the respective engaging blocks 40. The ratchet portion 61 of the ratchet element 60 is inserted into the through hole 31 of the assembling base 30 while an end of the passage portion 62 penetrates the drive assembling element 21 of the drive unit 20. A positioning buckle 63 is disposed on the end of the passage portion 62 which penetrates the drive unit 20.

The rotating cap 70 includes an engaging groove 71. In a bottom surface of the engaging groove 71 is centrally formed an insertion hole 711 correspondingly to the ratchet portion 61 of the ratchet element 60. Adjacent the insertion hole 711 is formed a push portion 712. The engaging groove 71 includes three engaging concaves 713 and a second annular groove 714 in an inner surface thereof. The rotating cap 70 rotatably covers the assembling base 30, and the ratchet portion 61 of the ratchet element 60 is inserted into the insertion hole 711 of the rotating cap 70. The push portion 712 of the rotating cap 70 is located in the moving space 44 correspondingly to the driven portions 42 of the two engaging blocks 40 in such a manner that the push portion 712 doesn't push against the driven portions 42 of the respective engaging blocks 40. The respective engaging concaves 713 are located correspondingly to the ball 34 of the assembling base 30 in such a manner that the ball 34 can be engaged into one of the engaging concaves 713 by rotating along with the rotating cap 70 to form three-segment adjustment. The second annular groove 714 is arranged opposite the first annular groove 36 of the assembling base 30, and a C-shaped buckle 72 is disposed between the first and the second annular grooves 36, 714 for preventing the rotating cap 70 from disengaging from the assembling base 30 in the axial direction X.

The handle 80 is drivingly connected to the ratchet element 60. In the present embodiment, the handle 80 is integral with the ratchet element 60.

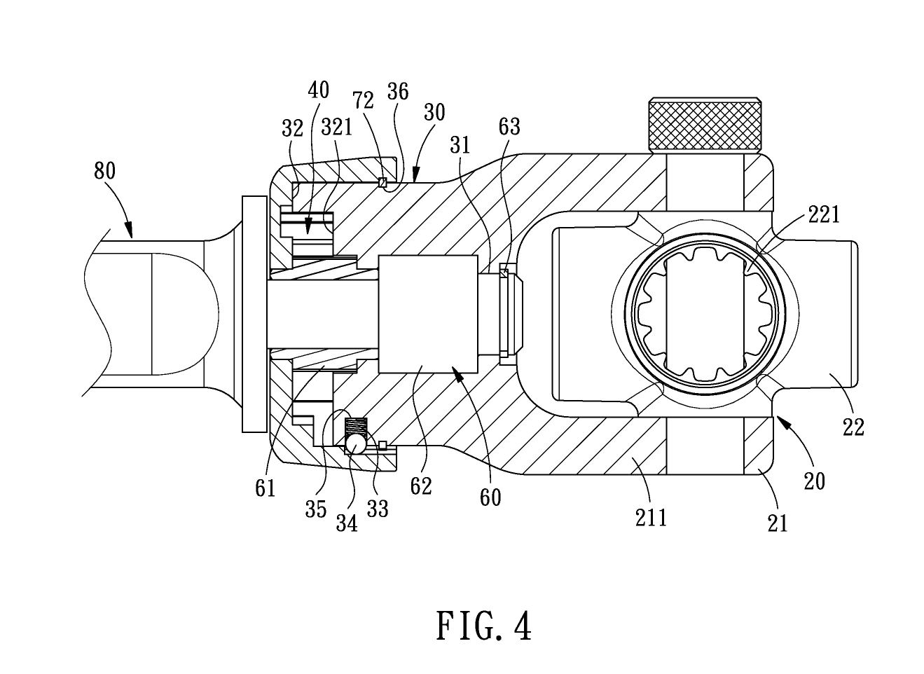

The aforementioned is the summary of the positional and structural relationship of the respective components of the multi-size ratchet socket wrench in accordance with the present invention. When in use, the user rotates the rotating cap 70 to enable the ball 34 of the assembling base 30 to be located in the different engaging concaves 713 of the rotating cap 70, so that the push portion 712 of the rotating cap 70 can be changed in position to selectively push or not push against the respective engaging blocks 40, as shown in FIGS. 4-6, enabling the drive unit 20 to be switched between idle and unidirectional-drive states. Since the drive unit 20 of the present invention includes the four different sized socket engaging ends 221, the size applicability is quite high. Between the drive unit 20 and the handle 80 is provided the ratchet unit, so that the drive unit 20 has a ratchet function. In addition, the multi-size ratchet socket wrench can also be applied in a narrow deep space, so that when in use, the user can rotate the handle 80 back and forth with only one hand to exert the ratchet function without having to use two hands.

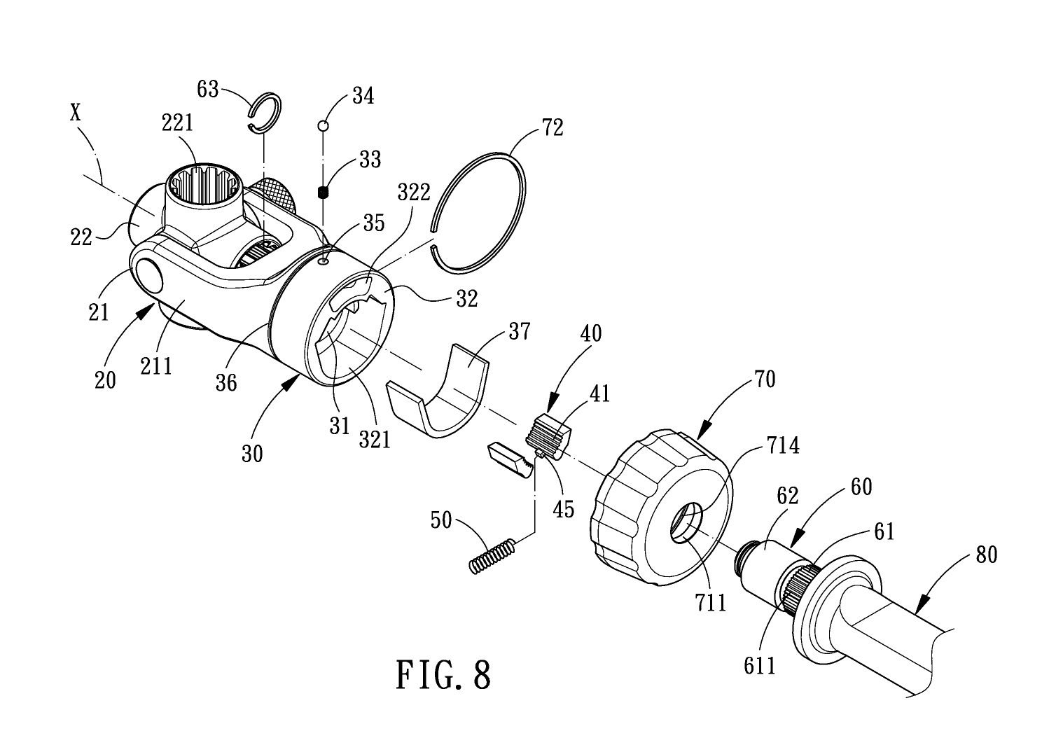

The drive unit 20 and the ratchet unit can also be disposed at both ends of the handle to achieve the above objective. In addition, FIGS. 8-11 show a multi-size ratchet socket wrench in accordance with a second embodiment of the present invention as follows.

The drive unit 20 is provided at a first end thereof with a driving assembling element 21 pivotally connected with a drive tool 22. The drive assembling element 21 is U-shaped and includes two opposite pivot ears 211 extending in an axial direction. The drive tool 22 in the present embodiment is cross-shaped in cross section and includes four different sized socket engaging ends 221 extending in different directions. The drive tool 22 is pivotally connected between the two pivot ears 211. Of course, the drive tool 22 can also includes other quantity of engaging ends 221.

An assembling base 30 is connected to a second end of the drive unit 20. In the present embodiment, the assembling base 30 is integral with the drive unit 20. The assembling base 30 is formed with a through hole 31 in the axial direction X and includes an end surface 32 in a direction vertical to the axial direction X. The assembling base 30 is formed with an accommodation groove 321 which is recessed in the end surface 32 and in communication with the through hole 31. The assembling base 30 is formed in an outer surface thereof with a ball groove 35 for accommodation of a ball 34 and a spring 33 and further formed with a first annular groove 36 around the surface thereof. The assembling base 30 is further formed with a moving groove 322 recessed in the end surface 32 in the axial direction X, and a reinforcing element 37 is accommodated in the accommodation groove 321 and abuts against an inner surface of the accommodation groove 321. In the present embodiment, the reinforcing element 37 is made of rigid material.

The ratchet unit is arranged between the drive unit 20 and the handle 80 to enable the drive unit 20 to be switched between idle and unidirectional-drive states with respect to the handle 80. The ratchet unit in the present embodiment includes two engaging blocks 40, an elastic element 50, a ratchet element 60 and a rotating cap 70.

Each of the two engaging blocks 40 is formed with ratchet teeth 41 in a direction of the through hole 31 and includes an assembling block 45 protruding from an end thereof. The two engaging blocks 40 are accommodated in the accommodation groove 321 of the assembling base 30. The two engaging blocks 40 are arranged in such a manner that the two assembling blocks 45 are located opposite each other. The elastic element 50 has both ends mounted on a first end of the respective assembling blocks 45 of the two engaging blocks 40 in the assembling base 30.

The ratchet element 60 includes a ratchet portion 61 and a passage portion 62 at both ends thereof. The ratchet portion 61 is formed on an outer surface thereof with plural ratchet teeth 611 to be engaged with the ratchet teeth 41 of the respective engaging blocks 40. The ratchet portion 61 of the ratchet element 60 is inserted into the through hole 31 of the assembling base 30 while the passage portion 62 penetrates the drive assembling element 21 of the drive unit 20.

The rotating cap 70 includes an engaging groove 71. In a bottom surface of the engaging groove 71 is centrally formed an insertion hole 711 correspondingly to the ratchet portion 61 of the ratchet element 60. The rotating cap 70 is further formed with two push portions 712 adjacent the insertion hole 711. The engaging groove 71 includes three engaging concaves 713 and a second annular groove 714 in an inner surface thereof. The engaging groove 71 is further formed with a fixture block 715.

The rotating cap 70 rotatably covers the assembling base 30, the passage portion 62 of the ratchet element 60 is inserted into the insertion hole 711 of the rotating cap 70, and the ratchet teeth 611 of the ratchet portion 61 of the ratchet element 60 are engaged with the ratchet teeth 41 of the respective engaging blocks 40. The two push portions 712 of the rotating cap 70 push against the second ends of the two engaging blocks 40, and the fixture block 715 of the rotating cap 70 is accommodated in the moving groove 322 of the assembling base 30.

The handle 80 is drivingly connected to the ratchet element 60. In the present embodiment, the handle 80 is integral with the ratchet element 60.

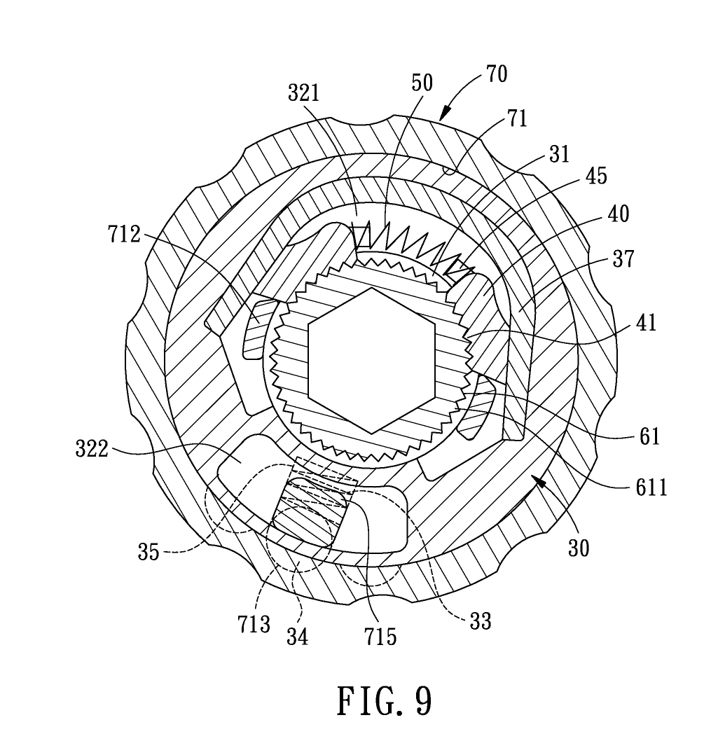

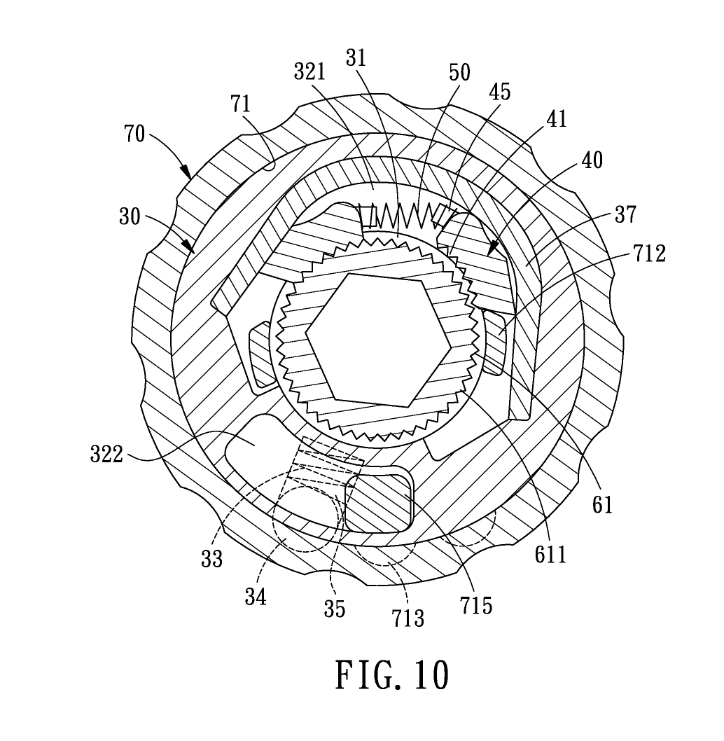

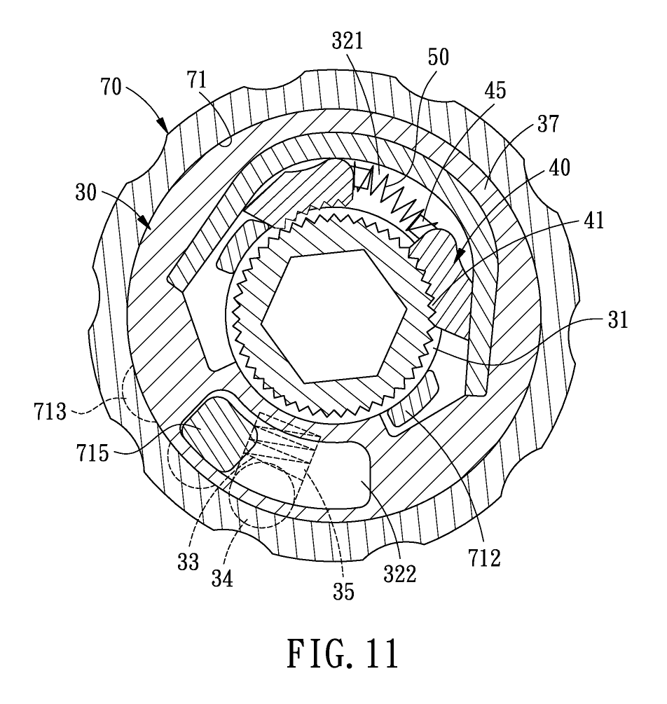

Thereby, when the ball 34 is accommodated in the middle one of the three engaging concave 71 the rotating cap 70, as shown in FIG. 9, the respective engaging blocks 70 are engaged with the ratchet teeth 611 of the ratchet portion 61 of the ratchet element 60, so that the drive unit 20 will loose the driving function. When the user rotates the rotating cap 70, the push portions 712 of the rotating cap 70 will push the respective engaging blocks 40 to make one of the engaging blocks 40 be engaged with the ratchet teeth 611 of the ratchet element 60, as shown in FIG. 10 or 11, so that the drive unit 20 can be in a unidirectional-drive state, namely rotating in one direction while rotating idly in the other direction. The drive unit 20 in the present embodiment includes the four different sized socket engaging ends 221, so that the size applicability is quite high. Between the drive unit 20 and the handle 80 is provided the ratchet unit, so that the drive unit 20 has a ratchet function. In addition, the multi-size ratchet socket wrench can also be applied in a narrow deep space, so that when in use, the user can rotate the handle 80 back and forth with only one hand to exert the ratchet function without having to use two hands while enhancing the convenience in use.

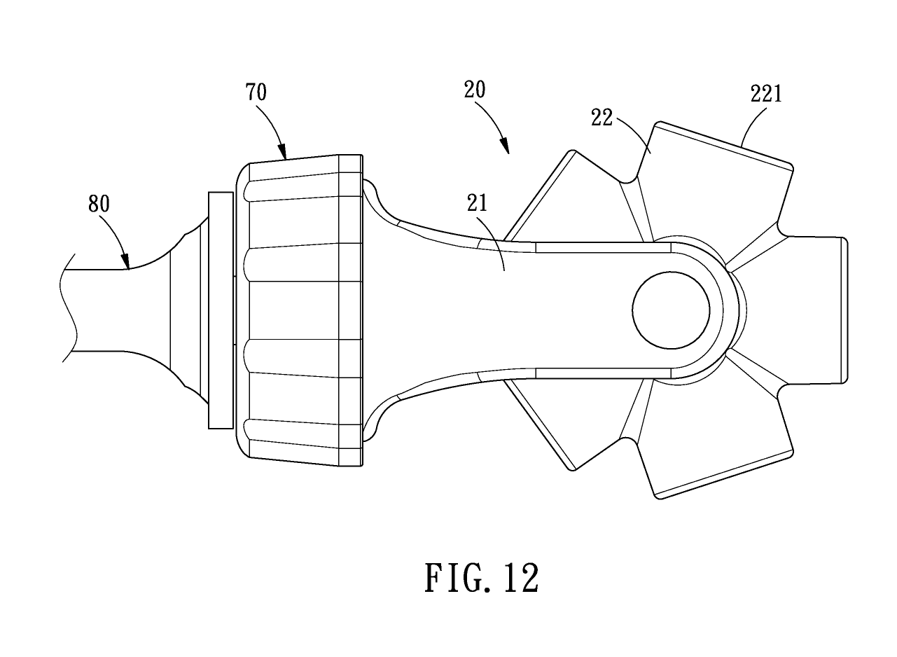

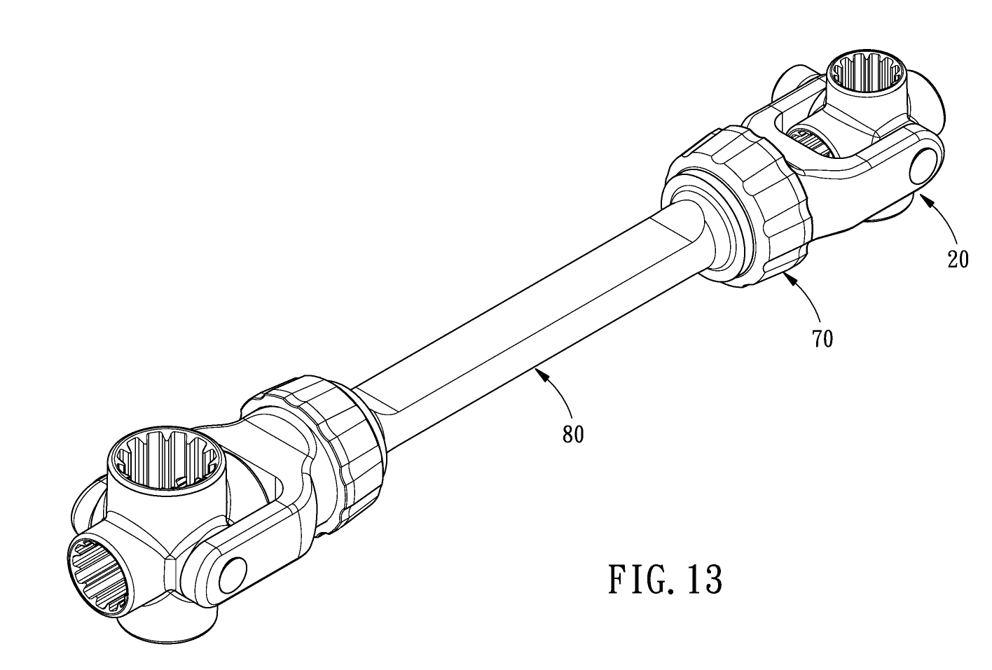

Additionally, referring to FIG. 12, the drive unit 20 can also be provided with five engaging ends 221, the applicability of the present invention can be further enhanced. Furthermore, as shown in FIG. 13, both ends of the handle 80 are provided with the drive unit 20 and the ratchet unit, so that the applicability of the present invention can also be further enhanced.

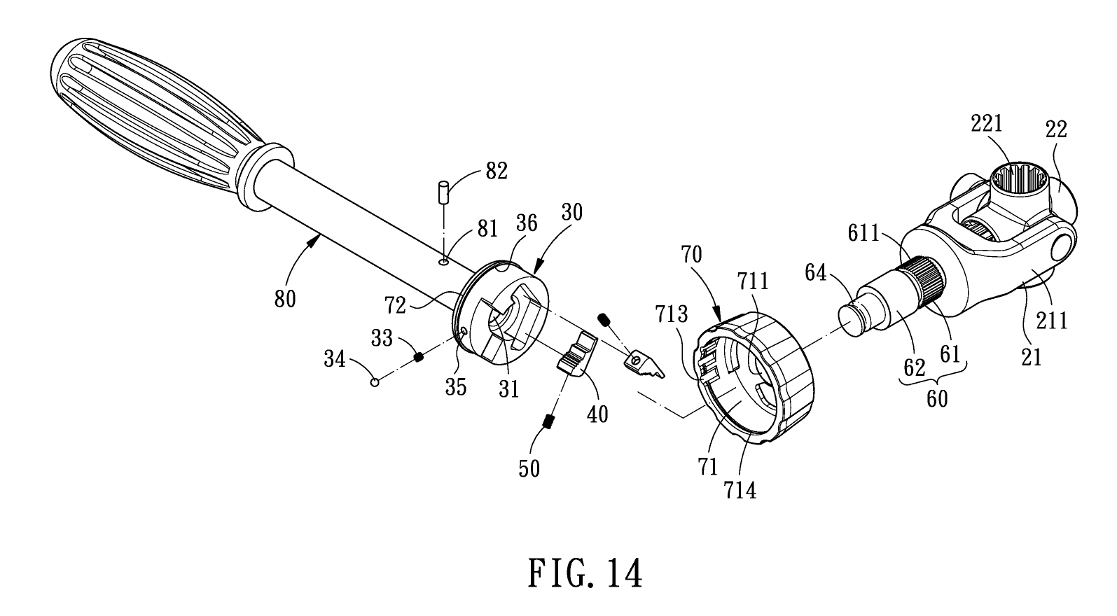

Moreover, referring to FIG. 14 showing a multi-size ratchet socket wrench in accordance with a third embodiment of the present invention, the drive unit 20 is integral with the ratchet element 60, and the assembling base 30 is integral with the handle 80. The handle 80 is further formed with a through penetration hole 81 used together with a bolt 82. The drive unit 20 is connected to the ratchet element 60 having the passage portion 62 thereof inserted through the insertion hole 711 of the rotating cap 70 and the through hole 31 of the assembling base 30, and the bolt 82 is inserted in the handle 80 and resists against an annular groove 64 of the ratchet element 60. The rotating cap 70 is rotatably mounted on the assembling base 30. The engaging blocks 40, the elastic element 60 are assembled in the same manner as the above embodiment, thereby, it can also achieve the same function as the above embodiment.

While we have shown and described various embodiments in accordance with the present invention, it is clear to those skilled in the art that further embodiments may be made without departing from the scope of the present invention.

What is claimed is:

1. A multi-size ratchet socket wrench comprising:
a drive unit being provided at a first end thereof with a drive assembling element which is pivotally connected with a drive tool, the drive assembling element being formed at an end thereof with two opposite pivot ears extending in an axial direction, the drive tool including different sized socket engaging ends extending in multiple directions, the drive tool being pivotally connected between the two pivot ears; and
a ratchet unit being arranged between the drive unit and a handle, the ratchet unit being selectively engaged to the handle and having different ratchet drive states.

2. The multi-size ratchet socket wrench as claimed in claim 1 further comprising an assembling base and a ratchet element, the ratchet unit including two engaging blocks, the assembling base being connected to the drive unit, the assembling base being formed with a through hole in the axial direction and an accommodation groove in communication with the through hole, the engaging blocks of the ratchet unit being accommodated in the accommodation groove, the ratchet element being formed on an outer surface thereof with plural ratchet teeth, the ratchet element being inserted into the through hole of the assembling base and connected to the drive unit.

3. The multi-size ratchet socket wrench as claimed in claim 2, wherein the engaging blocks elastically push against the assembling base.

4. The multi-size ratchet socket wrench as claimed in claim 2, wherein the ratchet unit further includes a rotating cap, the assembling base includes an end surface in a direction vertical to the axial direction, the accommodation groove is formed in the end surface, the assembling base is formed in an outer surface thereof with a ball groove for accommodation of a ball and a spring, the two engaging blocks are accommodated in the accommodation groove of the assembling base and selectively elastically engaged with the ratchet teeth of the ratchet element, the rotating cap is mounted on the ratchet element and covers the assembling base, the rotating cap is formed with at least one push portion correspondingly to the respective engaging blocks, the rotating cap is formed in an inner surface thereof with three engaging concaves for selectively engaging with the ball.

5. The multi-size ratchet socket wrench as claimed in claim 4, wherein the assembling base is further formed with a first annular groove in the outer surface thereof, the rotating cap is formed with a second annular groove in the inner surface thereof, between the first and the second annular groove is disposed a C-shaped buckle.

6. A multi-size ratchet socket wrench comprising:
a drive unit being provided at a first end thereof with a drive assembling element which is pivotally connected with a drive tool, the drive assembling element being formed at an end thereof with two opposite pivot ears extending in an axial direction, the drive tool including different sized socket engaging ends extending in multiple directions, the drive tool being pivotally connected between the two pivot ears;
an assembling base being integral with the drive assembling element of the drive unit;
a ratchet unit being integral with a handle and penetrating the assembling base; and
a ratchet unit being disposed on the assembling base and selectively engaged to the ratchet element to have different ratchet drive states with respect to the handle.

7. The multi-size ratchet socket wrench as claimed in claim 6, wherein the ratchet unit includes two engaging blocks, the assembling base is formed with a through hole in the axial direction and an accommodation groove in communication with the through hole, the engaging blocks of the ratchet unit are accommodated in the accommodation groove, the ratchet element is formed on an outer surface of a first end thereof with plural ratchet teeth, the ratchet element is inserted into the through hole of the assembling base and connected to the drive connecting element of the drive unit

8. The multi-size ratchet socket wrench as claimed in claim 7, wherein the engaging blocks elastically push against the assembling base.

9. The multi-size ratchet socket wrench as claimed in claim 8, wherein an elastic element is disposed between each of the engaging blocks and an inner surface of the accommodation groove.

10. The multi-size ratchet socket wrench as claimed in claim 7, wherein the ratchet unit further includes a rotating cap, the assembling base includes an end surface in a direction vertical to the axial direction, the accommodation groove is formed in the end surface, the assembling base is formed in an outer surface thereof with a ball groove for accommodation of a ball and a spring, the two engaging blocks are accommodated in the accommodation groove of the assembling base and selectively elastically engaged with the ratchet teeth of the ratchet element, the rotating cap is mounted on the ratchet element and covers the assembling base, the rotating cap is formed with at least one push portion correspondingly to the respective engaging blocks, the rotating cap is formed in an inner surface thereof with three engaging concaves for selectively engaging with the ball.

11. The multi-size ratchet socket wrench as claimed in claim 10, wherein the assembling base is further formed with a first annular groove in the outer surface thereof, the rotating cap is formed with a second annular groove in the inner surface thereof, between the first and the second annular groove is disposed a C-shaped buckle.

12. The multi-size ratchet socket wrench as claimed in claim 10, wherein the rotating cap includes an engaging groove, in a bottom surface of the engaging groove is centrally formed an insertion hole for insertion of the ratchet portion of the ratchet element, the at least one push portion is located adjacent to the insertion hole, the engaging groove includes three engaging concaves in an inner surface thereof, the rotating cap is mounted on a first end of the ratchet element and rotatably covers the assembling base, and a second end of the ratchet element penetrates the through hole of the assembling base.

13. The multi-size ratchet socket wrench as claimed in claim 9, wherein each of the two engaging blocks is formed with ratchet teeth in a direction of the through hole and includes a driven portion higher than the end surface of the assembling base and a side groove at a side thereof, the two engaging blocks are arranged in such a manner that the driven portions are located adjacent to each other, and between the two engaging blocks is defined a moving space, the ratchet unit further includes at least two elastic elements that are disposed in the respective side grooves of the engaging blocks, a first end of each of the elastic elements pushes against the corresponding side groove, and a second end of each of the elastic elements pushes against the inner surface of accommodation groove of the assembling base, the at least one push portion of the rotating cap is located in the moving space correspondingly to the driven portions of the respective engaging blocks.

14. The multi-size ratchet socket wrench as claimed in claim 12, wherein the ratchet element is formed at a second end thereof with a passage portion, an end the passage portion penetrates the drive unit, and a positioning buckle is disposed on the end of the passage portion which penetrates the drive unit.

15. A multi-size ratchet socket wrench comprising:
a drive unit being provided at a first end thereof with a drive assembling element which is pivotally connected with a drive tool, the drive assembling element being formed at an end thereof with two opposite pivot ears extending in an axial direction, the drive tool including different sized socket engaging ends extending in multiple directions, the drive tool being pivotally connected between the two pivot ears;
an assembling base being integral with the handle;
a ratchet unit being integral with the drive assembling element of the drive unit; and
a ratchet unit being disposed on the assembling base and selectively engaged to the ratchet element to have different ratchet drive states with respect to the handle.

16. The multi-size ratchet socket wrench as claimed in claim 15, wherein the ratchet unit includes two engaging blocks, the assembling base is formed with a through hole in the axial direction, the ratchet element is inserted through the through hole of the assembling base and connected to the assembling base, the assembling base is further formed with an accommodation groove in communication with the through hole thereof, the engaging blocks of the ratchet unit are accommodated in the accommodation groove, the ratchet element is formed on an outer surface of a first end thereof with plural ratchet teeth, the ratchet teeth of the ratchet element are selectively engaged to the respective engaging blocks.

17. The multi-size ratchet socket wrench as claimed in claim 16, wherein the engaging blocks elastically push against the assembling base.

18. The multi-size ratchet socket wrench as claimed in claim 16, wherein the ratchet unit further includes a rotating cap, the assembling base includes an end surface in a direction vertical to the axial direction, the accommodation groove is formed in the end surface, the assembling base is formed in an outer surface thereof with a ball groove for accommodation of a ball and a spring, the two engaging blocks are accommodated in the accommodation groove of the assembling base and selectively elastically engaged with the ratchet teeth of the ratchet element, the rotating cap is mounted on the ratchet element and covers the assembling base, the rotating cap is formed with at least one push portion correspondingly to the respective engaging blocks, the rotating cap is formed in an inner surface thereof with three engaging concaves for selectively engaging with the ball.

19. The multi-size ratchet socket wrench as claimed in claim 18, wherein the assembling base is further formed with a first annular groove in the outer surface thereof, the rotating cap is formed with a second annular groove in the inner surface thereof, between the first and the second annular groove is disposed a C-shaped buckle.

20. The multi-size ratchet socket wrench as claimed in claim 16, wherein the assembling base is further formed with a moving groove recessed in the end surface in the axial direction, and a reinforcing element is accommodated in the accommodation groove and abuts against an inner surface of the accommodation groove.

21. The multi-size ratchet socket wrench as claimed in claim 20, wherein the reinforcing element is made of rigid material.

22. The multi-size ratchet socket wrench as claimed in claim 20, wherein each of the two engaging blocks is formed with ratchet teeth in a direction of the through hole, the ratchet unit further includes an elastic element, each of the engaging blocks includes an assembling block protruding from an end thereof, the two engaging blocks are accommodated in the accommodation groove of the assembling base, the two engaging blocks are arranged in such a manner that the two assembling blocks are located opposite each other, the elastic element has both ends mounted on a first end of the respective assembling blocks of the two engaging blocks in the assembling base, the rotating cap is formed with an engaging groove, in a bottom surface of the engaging groove is centrally formed an insertion hole correspondingly to the ratchet portion of the ratchet element, the rotating cap is further formed with two push portions adjacent to the insertion hole, the engaging groove is further formed on the bottom surface thereof with a fixture block correspondingly to the moving groove, the two push portions of the rotating cap push against a second end of the respective engaging blocks, and the fixture block of the rotating cap is accommodated in the moving groove of the assembling base.
